(19) United States
(12) Patent Application Publication
(10) Pub. No.: US 2021/0094137 A1
(43) Pub. Date: Apr. 1, 2021

(54) MACHINE SYSTEM PERFORMING WORKPIECE MISS DETECTION

(71) Applicant: Fanuc Corporation, Minamitsuru-gun (JP)

(72) Inventors: Masafumi Ooba, Minamitsuru-gun (JP); Kentaro Koga, Minamitsuru-gun (JP)

(73) Assignee: Fanuc Corporation, Minamitsuru-gun (JP)

(21) Appl. No.: 16/940,647

(22) Filed: Jul. 28, 2020

(30) Foreign Application Priority Data
Sep. 27, 2019 (JP) 2019-177829

(51) Int. Cl. B23Q 17/22; B23Q 17/20; B23Q 5/38

(52) U.S. Cl. CPC B23Q 17/22; B23Q 5/38; B23Q 17/20

(57) ABSTRACT

A machine system includes a machine which performs an operation on a workpiece passing through an operational area, a miss detection section which detects that a workpiece has passed through an operation limit line of the machine in an incomplete operation state, and a notification section which notifies information related to the missed workpiece based on information of the miss detection section.

### BACKGROUND OF THE INVENTION

### 1. Field of the Invention

The present invention relates to a machine system which performs operations on moving workpieces, and in particular, relates to a machine system which performs workpiece miss detection.

### 2. Description of the Related Art

When an operation is performed on a moving workpiece using a machine such as an industrial robot, since the operation is performed on the workpiece within the operational area of the machine, in some cases the workpiece may pass through the operational area in an incomplete operation state due to the speed of the workpiece or the quantity of workpieces. Regarding such a machine system, for example, the literature described below is known.

Japanese Unexamined Patent Publication (Kokai) No. 2007-030087 discloses a logistics tracking device in which a most upstream side robot determines whether each workpiece can be handled, data of unhandled workpieces is sent to a downstream side robot, the downstream side robot determines whether or not to handle each workpiece based on the received data and then sends the data of unhandled workpieces to the most downstream robot.

Japanese Unexamined Patent Publication (Kokai) No. 2007-015055 discloses a handling device comprising a visual sensor which acquires images of a plurality of tracking ranges and detects the position of a workpiece, an encoder which detects a movement amount of a conveyor belt, a tracking manager which identifies a tracking range in transit based on the detected movement amount, a workpiece manager which selects an article that satisfies a specified condition within the identified tracking range, and a control section which controls a robot so as to grip the selected workpiece.

Japanese Unexamined Patent Publication (Kokai) No. 2018-069377 discloses a simulation device which simulates an article alignment operation in a virtual space, wherein a plurality of articles aligned in a regular arrangement are placed on a tray.

Japanese Unexamined Patent Publication (Kokai) No. 2017-056529 discloses a transport system comprising a robot which transfers a workpiece carried by a first conveyor to a placement plate carried by a second conveyor, and a robot controller which causes the robot to perform an operation of temporarily placing the workpiece acquired from the first conveyor in a temporary placement area when it is determined that workpieces have been excessively supplied to the placement plate.

### SUMMARY OF THE INVENTION

In general, workpieces missed by a machine are often treated as defects. Since yield will decrease if a missed workpiece is treated as a defect, the operator may return the workpiece to an upstream process in some cases. However, since the operator cannot predict when a defect will be generated, it is necessary to continuously monitor the system, which increases operator monitoring burden and labor costs. There is also a quality risk in that the missed workpiece may be mistakenly delivered to the ultimate consumer as a non-defective article. Further, it is not easy to determine how the workpiece was missed.

A technology which can detect workpiece misses in a machine system which performs operations on moving workpieces is desired.

An aspect of the present disclosure provides a machine system comprising a machine which performs an operation on a workpiece passing through an operational area, a miss detection section which detects that the workpiece has passed through an operation limit line of the machine in an incomplete operation state, and a notification section which notifies information related to the missed workpiece based on information of the miss detection section.

### BRIEF DESCRIPTION OF THE DRAWINGS

FIG. 1 is a perspective view showing the schematic configuration of a machine system according to an embodiment.

FIG. 2 is a block diagram of the machine system according to the embodiment.

FIG. 3 is a block diagram of a machine system according to another embodiment.

FIG. 4 is a perspective view showing a modified example of a machine system.

FIG. 5 is a flowchart showing the schematic operations of the machine system.

### DETAILED DESCRIPTION

The embodiments of the present disclosure will be described in detail below with reference to the attached drawings. In the drawings, identical or similar constituent elements are assigned the same or similar reference signs. Furthermore, the embodiments described below do not limit the technical scope of the invention or the definitions of the terms described in the claims.

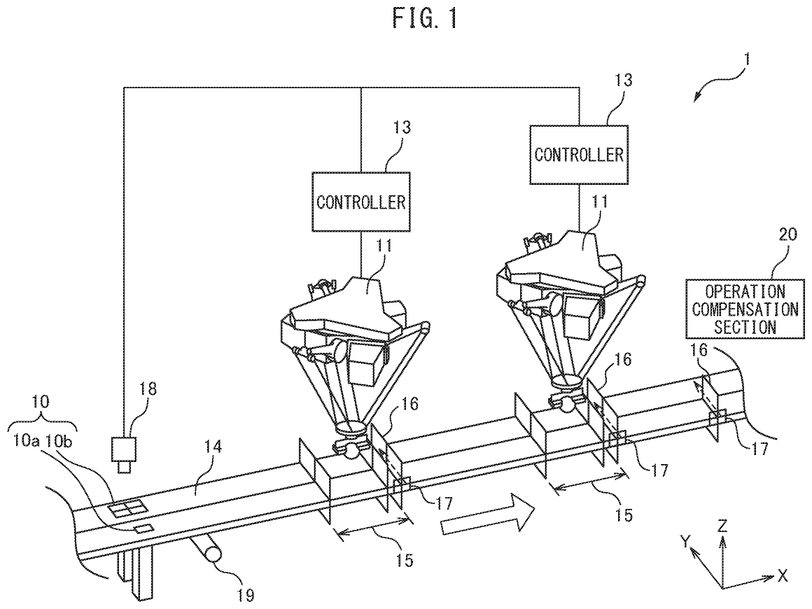

FIG. 1 shows the schematic configuration of a machine system 1 according to the present embodiment. The machine system 1 comprises one or a plurality of machines 11 which perform a predetermined operation on a workpiece 10, a tool 12 attached to the tip of the machine 11, and a controller 13 which controls the machine 11 and the tool 12. The workpiece 10 includes an article 10a or a tray 10b on which the article 10a can be placed, and is transported by a transport section 14, such as a conveyor or AGV (automated guided vehicle) so as to arrive at an operational area 15 of the machine 11. The machine 11 is a parallel link robot, but may be another industrial robot such as an articulated robot or may be another industrial machine such as a machine tool or construction machine. The tool 12 is a suction hand, which is used for positioning, for example, four articles 10a on one tray 10b. However, the tool 12 may be a hand comprising a plurality of fingers or another tool, for example, a sealing tool, a welding tool, a screw fastening tool, a soldering tool, or a laser machining tool, depending on the contents of the operation on the workpiece 10. The controller 13 may be a known controller comprising a processor such as a CPU (central processing unit).

Since the machine 11 performs an operation on a moving workpiece 10, in some cases the workpiece may pass through the operational area 15 in an incomplete operation state due to the speed of the workpiece or the quantity of workpieces. Thus, the machine system 1 comprises an operation limit line 16 for each machine 11, or comprises an operation limit line 16 for only the machine 11, among the plurality of machines 11, arranged most downstream, and is configured so as to perform workpiece 10 miss detection when the workpiece 10 passes through the operation limit line 16 in an incomplete operation state. Though the operation limit line 16 is provided on the downstream side within the operational area 15 in the direction of travel X of the workpiece, it may be provided further downstream than the operational area 15 of the machine 11 arranged most downstream (refer to the rightmost reference sign 16 in FIG. 1).

In order to perform workpiece 10 miss detection, the machine system 1 may comprise a first sensor 17 for monitoring the operation limit line 16. The first sensor 17 may be a two-dimensional camera or three-dimensional camera which is capable of detecting the workpiece 10. The machine system 1 may detect whether or not the workpiece 10 has passed through the operation limit line 16 or may detect whether or not the operation on the workpiece 10 has completed using the first sensor 17. As a result of the first sensor 17, it is possible to detect, for example, whether or not the article 10a has been placed on a predetermined location on the tray 10b, whether or not sealing, spot welding, etc., on a predetermined location of the article 10a has completed, etc.

Alternatively, the machine system 1 may comprise a second sensor 18 for detecting the arrival of the workpiece 10. The second sensor 18 may be a two-dimensional camera, three-dimensional camera, etc., which is capable of detecting the position, posture, movement amount, etc., of the workpiece 10, or may be a photoelectric sensor, contact sensor, etc., which is capable of detecting only the position of the workpiece 10. When the latter sensor is used, in addition to the second sensor 18, the machine system 1 may comprise a third sensor 19 which is capable of detecting the movement amount of the workpiece 10. The third sensor 19 may be a rotary encoder or the like attached to a rotary shaft of the transport section 14. The machine system 1 manages at least the current location of the workpiece 10 based on the information of the second sensor 18 and the information of the third sensor 19, in accordance with need, and without the use of the first sensor 17, based on at least the current location of the workpiece 10, may detect whether or not the workpiece 10 has passed through the operation limit line 16 in an incomplete operation state, or may detect whether or not the operation on the workpiece 10 has completed.

Alternatively, when the reference position of the workpiece 10 is known, the machine system 1 manages the current location of the workpiece 10 based on the movement amount of the workpiece 10 acquired by the third sensor 19, without the use of the first sensor 17 or the second sensor 18, and based on at least the current location of the workpiece 10, may perform determination as to whether or not the workpiece 10 has passed through a transport deceleration line 16b in an incomplete operation state, or may perform determination as to whether or not the operation on the workpiece 10 present between the operation limit line 16a and a transport acceleration line 16c has completed.

The machine system 1 notifies an operator or another device information related to the missed workpiece 10 based on the workpiece 10 miss detection. By notifying a workpiece miss, the operator or other device can take some sort of action on the workpiece at a desired timing. Further, the machine system 1 may comprise an operation compensation section 20 for compensating the operation based on the workpiece miss notification. The operation compensation section 20 is provided on the downstream side of the operation limit line 16, and comprises a dispenser which dispenses the missed article 10a or the missed tray 10b, a replenisher which replenishes the tray 10b missing an article 10a, or a transport machine which returns the missed article 10a or the missed tray 10b to the upstream of the operational area 15.

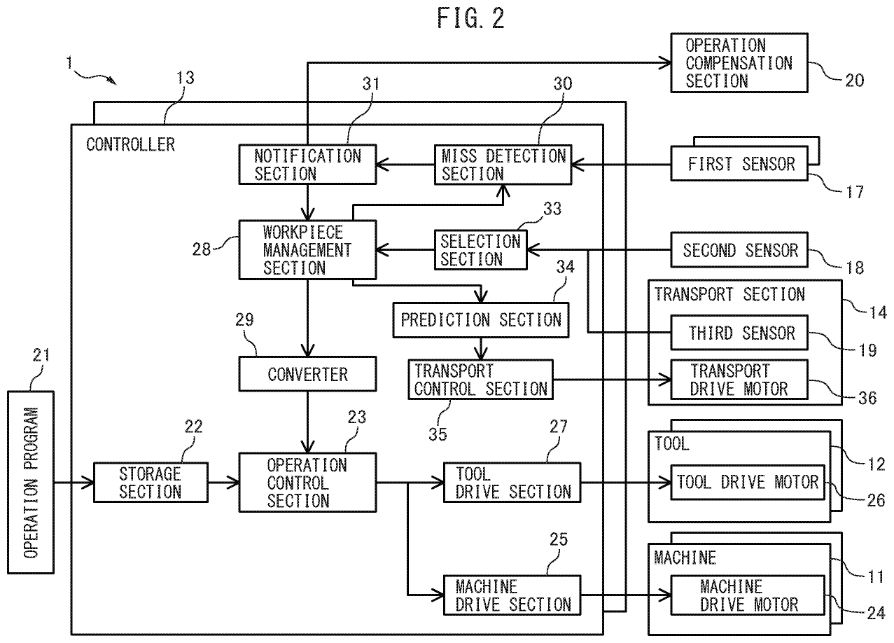

FIG. 2 shows the configuration of the machine system 1. The controller 13 comprises a storage section 22 which stores at least an operation program 21, an operation control section 23 which controls the operation of the machine 11 based on the operation program 21, a machine drive section 25 which drives a machine drive motor 24, and a tool drive section 27 which drives a tool drive motor 26. The operation program 21 is a program in which basic operation commands of the machine 11 are described in accordance with operation contents, and the operation control section 23 issues operation commands to the machine drive section 25 or tool drive section 27 based on the operation program 21. The machine drive section 25 or tool drive section 27 supplies power to the machine drive motor 24 or tool drive motor 26 based on the operation commands.

The controller 13 further comprises a workpiece management section 28 which manages information (current location, posture, movement amount, operation state, etc.) of the workpiece, and a converter 29 which converts the information (current location, posture, movement amount, etc.) of the workpiece from a sensor coordinate system to a machine coordinate system. The workpiece management section 28 can manage at least the current location of the workpiece using only the second sensor 18, using the second sensor 18 and the third sensor 19, or using only the third sensor 19 when the reference position of the workpiece is known in advance. Further, when the machine system 1 comprises a plurality of machines 11, the workpiece management section 28 may manage operation distribution of the workpiece to the plurality of machines 11. The workpiece management section 28 may manage the information of the workpiece using a workpiece database as shown in, for example, the following table. The workpiece database is synchronized or shared among a plurality of controllers 13.

TABLE 1

| | | Operation | Operation |
|---|---|---|---|
| Article No. | Current Location | Distribution | State |
| 1 | K420, Y12 | Machine No. 1 | Complete |
| 2 | X381, Y15 | Machine No. 1 | Incomplete |
| 3 | X286, Y13 | Machine No. 1 | Incomplete |
| 4 | K180, Y14 | Machine No. 1 | Incomplete |
| | | Placement | Placement |
| Tray No. | Current Location | Location 1 | Location 2 |
| 1 | K410, Y14 | Present | N/A |
| 2 | K381, Y15 | N/A | N/A |
| Tray | Placement | Placement | Operation |
| No. | Location 3 | Location 4 | State |
| 1 | N/A | N/A | Incomplete |
| 2 | N/A | N/A | Incomplete |

Workplace Movement Amount
20 cm/s

| Machine No. | Operational Area | Operation Limit Line |
|---|---|---|
| 1 | X200-X300 | X300 |
| 2 | X400-X500 | X500 |

When a workpiece arrives within the operational area, the workpiece management section 28 continuously transmits the information (current location, posture, movement amount, etc.) of the workpiece to the converter 29, and the converter 29 continuously converts the information (current location, posture, movement amount, etc.) of the workpiece from the sensor coordinate system to the machine coordinate system. The operation control section 23 continuously transmits, to the machine drive section 25, operation commands including a target operation (target position, target speed, target posture, etc.) of the machine in accordance with the information (current location, posture, movement amount, etc.) of the workpiece. As a result, the machine 11 can perform the operation while pursuing the workpiece. When the operation on the specific workpiece has completed, the workpiece management section 28 continuously transmits the information (current location, posture, movement amount, etc.) of a subsequent workpiece to the converter 29, and the operation described above is repeated. When the workpiece management section 28 manages the information (current location, posture, movement amount, etc.) of the workpiece in the machine coordinate system, the converter 29 may be provided between each sensor and the workpiece management section 28.

The controller 13 further comprises a miss detection section 30 for detecting workpiece misses, and a notification section 31 which notifies information related to the missed workpiece based on the information of the miss detection section 30. The miss detection section 30 detects whether or not the workpiece has passed through the operation limit line in an incomplete operation state using only the first sensor 17 or using the information of the workpiece management section 28. When the first sensor 17 is used, the miss detection section 30 may perform these determinations by detecting the workpiece by applying, for example, pattern matching or blob detection to the information of the first sensor 17.

When the information of the workpiece management section 28 is used, the miss detection section 30 may detect a miss of article No. 1 by, for example, referencing the workpiece database described above, and comparing the current location (X420) of article No. 1 with the position (X300) of the operation limit line of machine No. 1. Furthermore, the miss detection section 30 may detect a miss of tray No. 1 by, for example, referencing the workpiece database described above, comparing the current location (X410) of tray No. 1 with the position (X300) of the operation limit line of machine No. 1, and determining the presence or absence of articles in placement locations 1 to 4 of tray No. 1.

The miss detection section 30 performs the same miss detection in embodiments in which another operation, such as sealing or welding, is performed. The miss detection section 30 may determine, from the operation state, whether or not the operation on the sealing location or welding location of the workpiece has completed by, for example, referencing the workpiece database described above, and comparing the current location of the workpiece with the position of the operation limit line.

The notification section 31 notifies the operator or another device information related to the missed workpiece. Examples of the information related to the missed workpiece include the fact that the workpiece was missed, the number of missed workpieces, and the operation incomplete portion of the workpiece. By notifying the fact that a workpiece was missed or the number of missed workpieces, the operator or the other device can carry out some sort of process on the missed workpiece at the desired timing. Furthermore, by notifying the operation incomplete portion of the workpiece, the operation can be performed on only the operation incomplete portion. As a result of these workpiece miss notifications, the monitoring burden on the operator can be reduced, whereby yield can be improved and the risk of reduced quality can be reduced.

The notification section 31 notifies the information related to the missed workpiece to another device, such as the operation compensation section 20, the workpiece management section 28, etc. Based on the workpiece miss notification, the operation compensation section 20 performs operation compensation such as dispensing the missed article and missed tray, replenishing the tray missing an article, or returning the missed article or missed tray upstream of the operational area. Furthermore, when each machine is provided with an operation limit line, the workpiece management section 28 may distribute a missed workpiece to a downstream machine 11 based on the workpiece miss notification.

The controller 31 may further comprise a selection section 33 which performs selection of an operation target from among the plurality of workpieces based on information of the second sensor. The selection section 33 may perform selection of non-defective/defective articles based on, for example, the presence or absence of scratches, or may perform selection of the presence or absence of the operation based on the presence or absence of a label. In this case, the miss detection section 30 may detect whether or not the selected operation target has passed through the operation limit line in an incomplete operation state, or may simply detect whether or not a non-selected workpiece (for example, a defective article, etc.) has passed through the operation limit line.

The controller 13 may comprise a prediction section 34 which predicts whether or not the workpiece will pass through the operation limit line in an incomplete operation state based on the information of the workpiece management section 28 and the cycle time of the machine 11, and a transport control section 35 which controls transport of the workpiece based on the prediction results. The prediction section 34 predicts whether or not article No. 2 will pass through the operation limit line in an incomplete operation state by, for example, referencing the workpiece database described above, calculating the arrival time (t₂=d₂/v) at which article No. 2 will arrive at the operation limit line based on the movement amount (v=20 cm/s) of the workpiece and the distance (d₂=X500−X380) of article No. 2 to the operation limit line, and comparing the arrival time (t₁) with the cycle time (c) (t₂−c>0). Further, the prediction section 34 performs the same prediction for article No. 3 to arrive next (t₃−2c>0). When it is predicted that article No. 3 will pass through the operation limit line in an incomplete operation state (t₃−2c≤0), the transport control section 35 drives a transport drive motor 36 at the transport speed (v′<d₃/2c) so that article No. 3 does not pass through the operation limit line in an incomplete operation state.

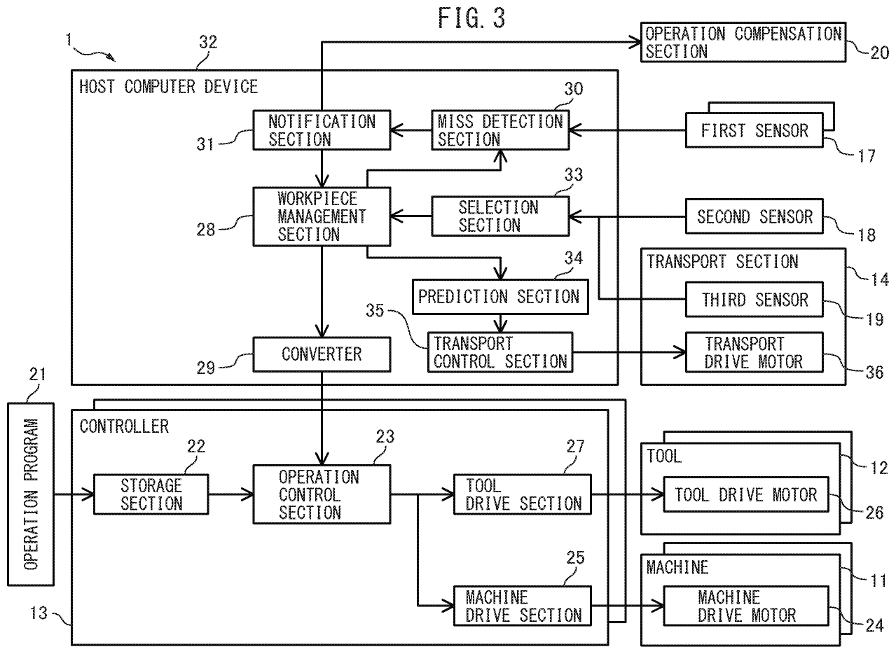

FIG. 3 shows the configuration of a machine system 1 according to another embodiment. In this configuration, the machine system 1 comprises a host computer device 32, and the host computer device 32 is communicably connected to each controller 13. The host computer device 32 is configured so as to process the information from each sensor, such as the first sensor 17, the second sensor 18, and the third sensor 19, at high speed, and issue various commands to each controller 13 based on the processing results. The workpiece management section 28, the converter 29, the miss detection section 30, the notification section 31, the selection section 33, the prediction section 34, and the transport control section 35 are not individually provided in each controller, but are integrated in the host computer device 32. As a result, various programs and various data can be shared between the plurality of controllers 13, whereby the maintainability of the machine system 1 can be increased.

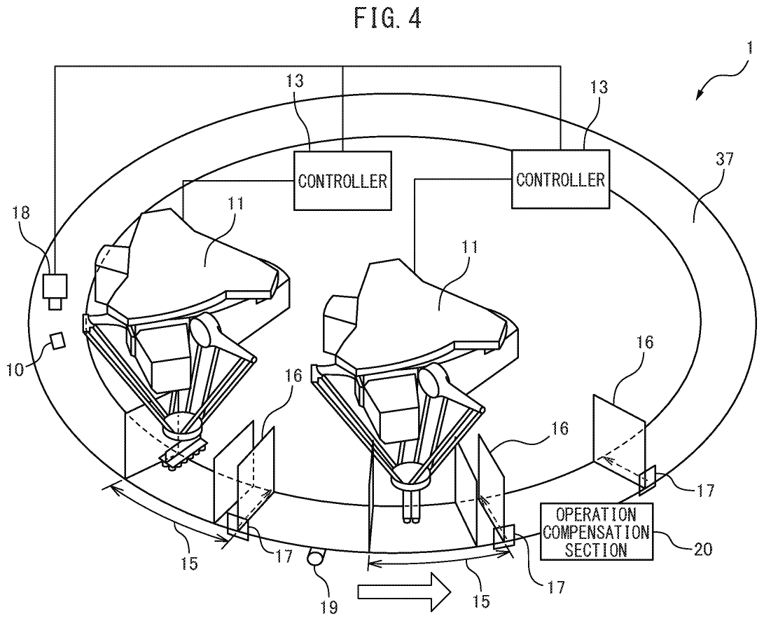

FIG. 4 shows a modified example of the machine system 1. In this modified example, the operation compensation section 20 comprises a circulating conveyor 37. The circulating conveyor 37 dispenses the workpiece 10 if there are no workpiece 10 miss notifications and returns the missed workpiece 10 to the upstream of the operational area 15 if there is a workpiece 10 miss notification. As a result, the machine 11 can again perform the operation on the missed workpiece 10.

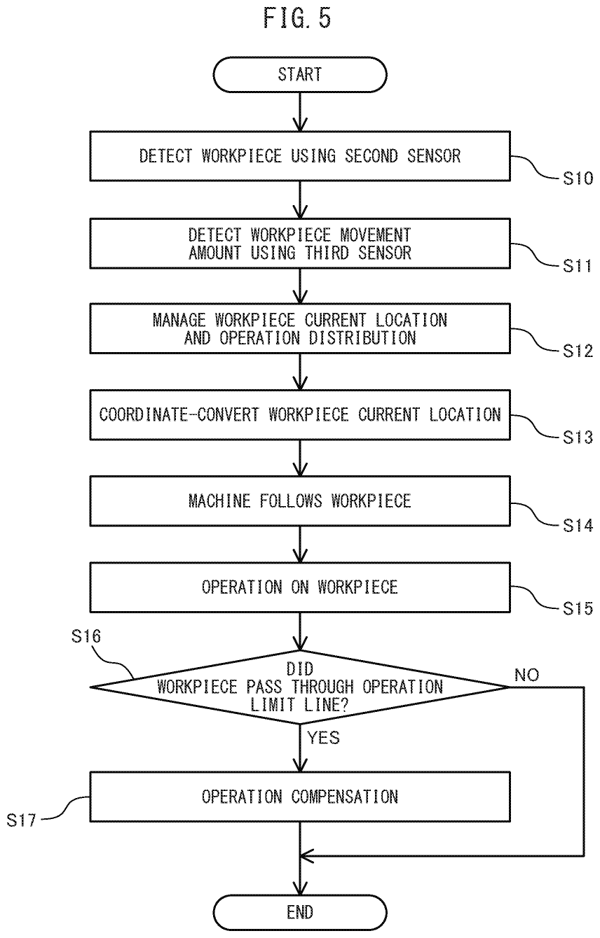

FIG. 5 shows the schematic operations of the machine system 1. In step S10, at least the position of the workpiece is detected using the second sensor, and in step S11, the movement amount of the workpiece is detected using the third sensor. However, when the second sensor can also detect the movement amount of the workpiece, since the current location of the workpiece can be managed with the second sensor alone, the process of step S11 is unnecessary. Furthermore, when the reference position of the workpiece is known in advance, since the current location of the workpiece can be managed with the third sensor alone, the process of step S10 is unnecessary.

In step S12, at least the current location of the workpiece is managed. When a plurality of machines are provided, the operation distribution of workpieces to the plurality of machines may be managed. In step S13, at least the current location of the workpiece is coordinate-converted from the sensor coordinate system to the machine coordinate system. However, when the information (current location, posture, movement amount, etc.) of the workpiece is managed in the machine coordinate system, the process of step S13 may be performed between step S11 and step S12.

In step S14, the machine pursues the workpiece based on the information (current location, posture, movement amount, etc.) of the workpiece. In step S15, the operation on the workpiece is performed using the tool. In step S16, it is determined whether or not the workpiece has passed through the operation limit line in an incomplete operation state. When the workpiece has passed through the operation limit line in an incomplete operation state (YES in step S16), in step S17, a workpiece miss notification is issued to the operator or another device, and operation compensation is performed. When the workpiece has not passed through the operation limit line in an incomplete operation state (NO in step S16), workpiece miss notification is not performed.

According to the embodiments above, since a missed workpiece 10 is detected by the machine 11 and information related to the missed workpiece is notified, the operator or another device can carry out some sort of process on the workpiece 10 at a predetermined timing. As a result of workpiece miss notification, the monitoring burden on the operator can be reduced, whereby the yield can be improved and the risk of reduced quality can be reduced.

The “sections” described above may be constituted by semiconductor integrated circuits, or may be constituted by programs which are executed by a processor. Furthermore, the program for executing the flowchart described above may be stored and provided on a computer-readable non-transitory record medium, for example, a CD-ROM.

Though various embodiments have been described in the present description, the present invention is not limited to the embodiments described above, and various modifications can be made within the scope described in the claims below.

1. A machine system, comprising:
a machine which performs an operation on a workpiece passing through an operational area,
a miss detection section which detects that the workpiece has passed through an operation limit line of the machine in an incomplete operation state, and
a notification section which notifies information related to the missed workpiece based on information of the miss detection section.

2. The machine system according to claim 1, further comprising a first sensor which detects the workpiece which has passed through the operation limit line, wherein the miss detection section detects whether or not the workpiece has passed through the operation limit line in an incomplete operation state based on information of the first sensor.

3. The machine system according to claim 1, further comprising a second sensor which detects the workpiece arriving at the operational area, and a workpiece management section which manages at least a current location of the workpiece based on at least information of the second sensor, wherein the miss detection section detects whether or not the workpiece has passed through the operation limit line in an incomplete operation state based on information of the workpiece management section.

4. The machine system according to claim 3, further comprising a third sensor which detects a movement amount of the workpiece.

5. The machine system according to claim 1, further comprising a third sensor which detects a movement amount of the workpiece, and a workpiece management section which manages at least a current location of the workpiece based on at least information of the third sensor, wherein the miss detection section detects whether or not the workpiece has passed through the operation limit line in an incomplete operation state based on information of the workpiece management section.

6. The machine system according to claim 5, further comprising a second sensor which detects the workpiece arriving at the operational area.

7. The machine system according to claim 5, comprising a plurality of the machines, wherein the workpiece management section further manages operation distribution of the workpiece to the plurality of machines.

8. The machine system according to claim 5, comprising a plurality of the machines, wherein each of the machines is provided with the operation limit line, and if the workpiece has passed through the operation limit line in an incomplete operation state, the workpiece management section distributes the missed workpiece to a downstream machine.

9. The machine system according to claim 6, further comprising a selection section which selects an operation target from among a plurality of the workpieces based on information of the second sensor, wherein the miss detection section detects whether or not the selected operation target has passed through the operation limit line in an incomplete operation state and detects whether or not the workpiece which was not selected passes through the operation limit line.

10. The machine system according to claim 5, further comprising:
a prediction section which predicts whether or not the workpiece will pass through the operation limit line in an incomplete operation state based on information of the workpiece management section and a cycle time of the machine, and
a transport control section which controls transport of the workpiece based on the prediction.

11. The machine system according to claim 1, comprising a plurality of the machines, wherein only the machine arranged most downstream among the plurality of the machines is provided with the operation limit line.

12. The machine system according to claim 1, wherein the operation limit line is provided downstream within the operational area in a direction of travel of the workpiece.

13. The machine system according to claim 1, wherein information related to the missed workpiece includes at least one of the fact that the workpiece was missed, the number of missed workpieces, and an operation incomplete portion of the workpiece.

14. The machine system according to claim 1, further comprising an operation compensation section which compensates the operation based on the notification.

15. The machine system according to claim 14, wherein the operation compensation section comprises a dispenser which dispenses the missed workpiece, a replenisher which replenishes the workpiece, or a transport machine which returns the missed workpiece upstream of the operational area.

16. The machine system according to claim 14, wherein the operation compensation section includes a circulating conveyor which returns the missed workpiece upstream of the operational area.

17. The machine system according to claim 1, wherein the machine performs the operation while pursuing the workpiece based on a current location of the workpiece.

18. The machine system according to claim 1, wherein the workpiece comprises an article or a tray on which the article can be placed.

19. The machine system according to claim 1, wherein the machine comprises a robot or an industrial machine.
